(19) United States
(12) Patent Application Publication
(10) Pub. No.: US 2003/0191573 A1
(43) Pub. Date: Oct. 9, 2003

(54) Method and device for indicating the driving state of a vehicle to the driver

(76) Inventors: Stefan Beyer, Aidlingen (DE); Martin Moser, Fellbach (DE); Reinhold Schneckenburger, Rutesheim (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/296,474

(22) PCT Filed: Apr. 14, 2001
(86) PCT No.: PCT/EP01/04284

(30) Foreign Application Priority Data
May 23, 2000 (DE) 100 25 492.6

(51) Int. Cl. B60T 8/00

(52) U.S. Cl. 701/70

(57) ABSTRACT

The invention relates to a method for providing feedback on the current driving state of a vehicle having a plurality of driving system devices to the driver, and a device for carrying out the method.

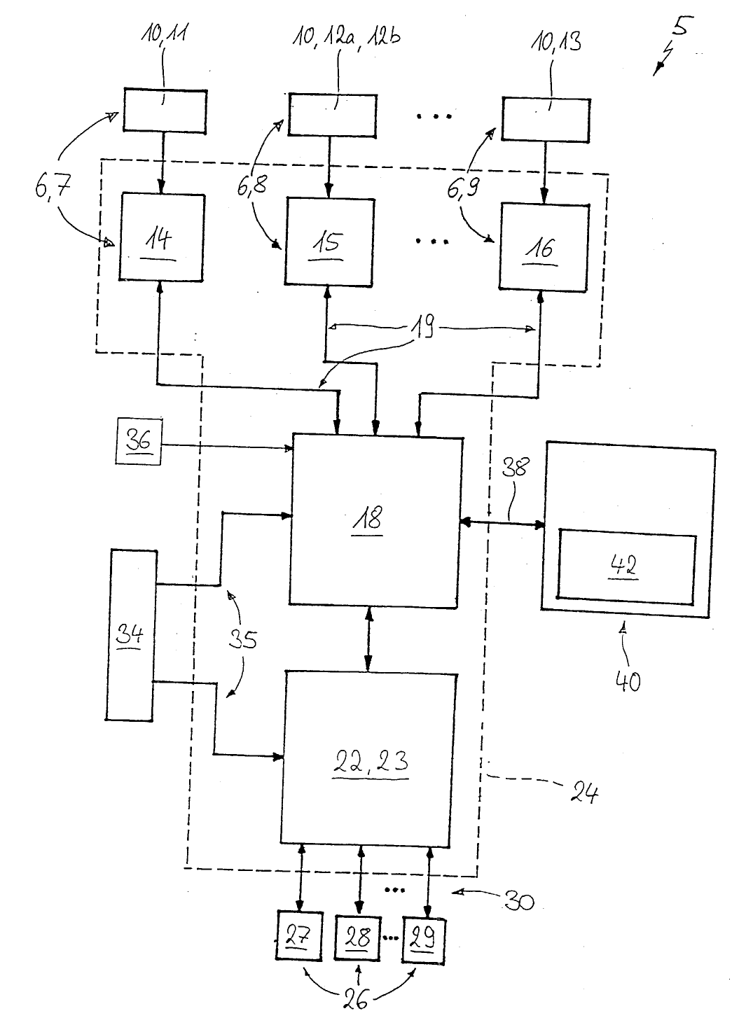

The driving system devices bring about, as a function of the current driving state, output signals from which a feedback signal for a feedback arrangement of the vehicle is generated. In order to communicate information on the current driving state, the feedback arrangement brings about a driver feedback message.

The invention relates to a method and a device for providing feedback on the current driving state of a vehicle, in particular motor vehicle, having a plurality of driving system devices to the driver.

Such a driving system device is, for example, a distance controlling device for controlling the distance from a vehicle travelling ahead (known under the term “Distronic” by the applicant), a speed control device (cruise controller), a collision avoidance device (for example by detecting oncoming vehicles when overtaking), a tyre pressure monitoring device, a bend warning device for providing prompt warning, when travelling at a high longitudinal vehicle speed, against bends, which can also bring about braking interventions and/or steering interventions in a further expansion stage, in order to prevent a bend being travelled through at an unacceptably high speed, or any other driving system device which can be made available to the driver as an aid.

Such driving system devices can, on the one hand, merely perform a warning function in order to inform the driver of a specific driving state, for example if the tyre pressure is not in a permitted range. However, there is also the possibility of the driving system devices automatically influencing the driving state, for example by means of a steering intervention or brake intervention, without the manual intervention of the driver. For example, in some vehicles from the applicant, a distance control device may be provided which already automatically brakes the vehicle when the distance from the vehicle travelling ahead is too small.

These driving system devices also have the purpose of informing the driver whether an automatic intervention for influencing the driving state is being carried out at a given time and/or whether a critical driving state of the vehicle is present. If there are a plurality of driving system devices in the vehicle, the items of information communicated to the driver may, owing to their number, confuse and overtax the driver, in particular if, in critical driving situations, a plurality of driving system devices simultaneously communicate items of information to the driver who is already highly stressed by the critical driving situation itself.

Taking this is a starting point, the present invention is based on the object of providing a method and a device for carrying out the method in order to provide the driver with sufficient information on the driving state when a plurality of driving system devices are integrated into one vehicle, the intention being to avoid the driver being overtaxed.

This object is achieved according to the features of claims 1 and 12.

The driving system devices provided in the vehicle generate output signals as a function of respectively determined driving state variables. The output signals constitute request signals for providing feedback on the driving state to the driver. They are sent to a coordination device which, as a function of the simultaneously present output signals, generates a feedback signal which is fed to the feedback arrangement, which then, as a function of the received feedback signal, in turn brings about a driver feedback message which conveys information to the driver.

Advantageous refinements of the method and of the device according to the invention emerge from the respective dependent claims.

The driver feedback can be visual and/or audible and/or haptic driver feedback. The visual driver feedback can be provided by means of suitable display devices such as displays, illuminated symbol panels or the like. In order to provide audible driver feedback, the existing loudspeakers of the audio system in the vehicle can be used, the acoustic output being able to take the form of sounds, signals and/or language. In the case of haptic driver feedback, the driver is provided with, in particular, feedback forces or feedback torques, for example by means of the operator controls, such as the steering operator control, brake operator control etc., which can be handled by the driver.

In order to generate the feedback signal, the present output signals of the driving system devices are expediently prioritized. The feedback signal takes into account here the importance of the present output signals for the driver, the priority of the output signals corresponding to their weighting. The output signals with a higher priority have precedence of use over the output signals with a lower priority.

It is advantageous if the driving system devices are divided into a plurality of groups with different group priorities, the output signals of a group with relatively high group priority having precedence of use, in the generation of the feedback signal, over the output signals of the driving system devices of a group with lower group priority. Here, the driving system devices can be divided, in terms of their function, into groups. For example, the driving system devices which request automatic safety intervention can be assigned to a group with high group priority, and the driving system devices which only serve to warn the driver can be assigned to a group with low group priority. It is possible here to take into account only the output signals of the driving system devices of a single group of driving system devices in order to generate the feedback signal.

It is also expedient if each output signal of the driving system devices is assigned a predefinable driver feedback message. If the feedback signal takes into account only one output signal, for example by means of a corresponding prioritization of the output signals, the driver feedback can easily be determined and brought about in a feedback arrangement.

In a further advantageous embodiment, each feedback signal is assigned a predefinable driver feedback message. Even if the feedback signal is composed of a plurality of output signals or takes into account a plurality of output signals here, each possible feedback signal can be assigned a specific feedback message.

Here, the driver feedback signal can be generated, for example in the feedback arrangement, as a function of the combination of the output signals taken into account.

A feedback message can also be stored and correspondingly called for each possible feedback signal.

Furthermore, it is advantageous if, in addition to the output signals, additional signals such as, for example, sensor signals from vehicle sensors which contain information relating to the driving state of the vehicle and/or setting signals which correspond to manual settings or values preset by the driver, are taken into account in the generation of the feedback signal. More extensive information is available to the assessment as to which driver feedback message is to be requested by means of the feedback signal, so that the driver can be informed in a more targeted way, and the weighting of the output signals which are present can be assessed better.

In one expedient refinement of the device for carrying out the method according to the invention, the feedback arrangement has, for bringing about the haptic driver feedback, a feedback actuator unit which serves to convey at least some of the variables occurring during the driving, such as forces or torques, to the driver by bringing about feedback forces which act on the driver. These feedback variables can be applied, in the form of feedback forces or feedback torques, in particular to electronic or electrical operator controls (X-by-wire operator controls such as electrical brake operator control or electrical steering operator control), in order to provide the driver with a realistic and accustomed operator control sensation.

It is possible here for the feedback signal to be formed in such a way that the feedback variables which are brought about in the feedback actuator unit are influenced when a critical driving state is present, in order to inform or warn the driver. For example, the feedback steering forces on which the driver is given feedback by means of the steering operator control while driving can be varied in terms of their timing when a critical driving state is present so that, for example, the steering operator control is made to vibrate. The feedback variables for the haptic feedback on which the driver is given feedback during the uncritical, normal driving mode of the vehicle, can be changed in order to provide the driver with specific information, for example about the occurrence of a critical driving state.

It is advantageous if the feedback actuator unit has, for providing the driver with feedback on the wheel steering force acting on the steerable wheels of the vehicle counter to the deflection movement of the wheels during steering, a steering simulation actuator which generates, at the steering operator control, a feedback steering variable which correlates to the wheel steering force. The feedback variable may be, for example, a feedback steering torque or a feedback steering force which is applied to the steering operator control by the steering simulation actuator.

In order to provide the driver with feedback on the braking behaviour of the vehicle, the feedback actuator unit can have a brake simulation actuator which brings about, at the brake operator control, a feedback brake variable which correlates to the braking behaviour of the vehicle, in particular to the braking force. This configuration is considered in particular in an electric operator brake control. As a result, even in uncritical driving situations, when the brake operator control is actuated the driver is provided with an operator control sensation which corresponds to the degree of the activation. The precise relationship between the degree of the actuation and the feedback brake variable which is generated, in particular the feedback braking force, can be predefined as desired.

Furthermore, it is expedient if, for providing the driver with feedback in particular on an unacceptable yaw behaviour of the vehicle, the feedback actuator unit has a rolling angle influencing actuator which influences the rolling angle. The rolling angle can be conveyed to the driver as a measure of the yaw behaviour of the body of the vehicle. A large rolling angle can indicate to the driver that the vehicle is approaching an unstable driving state or is in an unstable driving state.

In a further advantageous embodiment, the coordination device is connected to a driving state adjustment or control unit, in particular driving dynamics control unit, the driving state adjustment or control unit being able to transmit to the coordination device a driving state signal which is taken into account in the generation of the feedback signal. A further signal is thus available to the coordination device for evaluating the weighting of the output signals of the driving system devices and for bringing about a corresponding feedback signal.

Here, the driving state adjustment or control unit can be connected to vehicle actuator devices such as steering angle actuator device or brake actuator device, the vehicle actuator devices being able to communicate their operating state to the driving state adjustment or control unit which takes into account the operating state of the vehicle actuator devices when the driving state signal is produced. The failure or the malfunction of specific vehicle actuator devices can thus also be taken into account in the generation of the feedback signal.

The method and the device according to the invention will be explained in more detail below with reference to the appended drawing. The single FIGURE shows a block diagram of an embodiment of the device according to the invention.

The FIGURE is a block diagram of the device 5 according to the invention, which is used to coordinate a plurality of driving system devices 6 in a vehicle—in particular motor vehicle or passenger car—which is not illustrated in more detail. The number of driving system devices 6 which are present can basically be chosen as desired and depends on the equipment of the vehicle.

The driving system devices 6 are divided, by way of example, into safety, comfort and warning system devices and can also be referred to as driver aids. They are provided to support the driver in specific driving states or driving situations of the vehicle.

The safety system device which is provided in the exemplary embodiment is formed by a brake/steering aid 7 (referred to as “advanced brake assist”) which can carry out braking and steering interventions automatically as a function of detected obstacles on the carriageway in order to avoid a collision with the obstacle. Furthermore, a possible safety system device is a bend safety device (“intelligent predictive system”) which detects bends in advance by means of GPS and, if appropriate, adapts the speed of the vehicle in good time to the radius of the bend before the bend by means of a braking intervention in order to prevent unstable driving states of the vehicle when travelling through a bend.

The comfort system device which is present for example is implemented as a distance control device 8 (known as “Distronic” by the applicant), which performs braking interventions as a function of the distance from a vehicle travelling ahead in order to maintain a predefined safety distance. A possible comfort system device is also a driving system device 6 which is referred to as “Staumatic” and which permits the vehicle to be driven autonomously in congested traffic, automatic steering and braking being performed.

The warning system device provided according to the FIGURE is a tyre pressure warning device 9 which warns the driver audibly and/or visually and/or haptically about an excessively low or excessively high tyre pressure in one of the tyres of the vehicle. Instead of, or in addition to, the tyre pressure warning device, a hazard warning device could also be provided, which warns the driver about bends, complicated intersections or the like, if the longitudinal speed of the vehicle is not adapted to the respective hazard. The hazard may, for example, be detected in advance by means of GPS.

Furthermore, further safety, comfort and warning system devices are known which, in contrast to the illustrated exemplary embodiment, may be provided in the vehicle as a driving system device 6 in any desired number and any desired combination.

The driving system devices 6 each have one or more sensors 10 which are illustrated merely schematically in the figures. The brake/steering aid 7 has, for example, at least one radar sensor 11 for detecting obstacles in the surroundings of the vehicle. The distance control device 8 has a radar sensor 12a for determining the distance from the vehicle travelling ahead and a longitudinal vehicle speed sensor 12b. The tyre pressure warning device 10 contains a plurality of tyre pressure sensors 13 for measuring the tyre pressure in each of the tyres of the vehicle.

The driving system devices 6 also each have a driving system control unit 14 or 15 or 16 which is connected to a coordination device 18 via a first electrical conductor arrangement 19. Here, each driving system control unit 14, 15, 16 can be connected separately to the coordination device 18 or the first conductor arrangement 19 can be embodied as a bus system via which the driving system devices 6 and the coordination device 18 can communicate.

A driving state adjustment or control unit 22, which is formed, for example, by a driving dynamics control unit 23, is connected to the coordination device 18. The ESP control unit, which is already present nowadays in the vehicles of the applicant, is possible, for example, as a driving dynamics control unit 23.

The coordination device 18 can be integrated, together with the driving state adjustment or control unit 22 and/or the driving system control units 14, 15, 16 of the driving system devices 6, in a central processor unit 12. According to the figure, in the preferred exemplary embodiment the coordination device 18, the driving state adjustment or control unit 22 embodied as a driving dynamics control unit 23 and the driving system control units 14, 15, 16 are combined as one component in the central unit 24, said combination being illustrated schematically by a dashed line.

The vehicle can have a plurality of actuator devices 26 for influencing the movement of the vehicle in the longitudinal direction (x direction), in the transverse direction (y direction) and in the vertical direction (z direction) of the vehicle. According to the figure, in the exemplary embodiment the brake device 27, the steering device 28 and an engine control device 29 form the actuator devices 26 which can be actuated. The brake device 27, steering device 28 and engine control device 29 are connected to the driving dynamics control unit 23 in order to communicate by means of an electrical second conductor arrangement 30.

It should be noted that the actuator devices 26 can also have an active spring and damper device, a gearbox control device or the like. Combinations of any desired actuator devices 26 which can be actuated are possible here in any desired number.

In order to determine current driving state information, a sensor arrangement 34 is provided which is connected, for example, to the coordination device 18 and to the driving dynamics control unit 23 via a third electrical conductor arrangement 35. The sensor arrangement 34 comprises sensors for determining the yaw angle speed, the longitudinal speed of the vehicle, the longitudinal acceleration of the vehicle, the transverse acceleration of the vehicle, the wheel speeds and the steering torque. The sensor signals of the sensor arrangement 34 contain information on the overall driving state of the vehicle.

Basically, any desired driving state information which the coordination device 18 and/or the driving dynamics control unit 23 require can be determined by means of the sensor arrangement 34. For example, the acceleration of the vehicle in the z direction (direction of the vertical axis of the vehicle), the steering wheel angle, the transverse acceleration of the vehicle or the speed of the vehicle in the z direction can also be determined in the sensor arrangement 34 and communicated to the coordination device 18 and the driving dynamics control unit 23 as information on the instantaneous driving state of the vehicle.

The sensors of the sensor arrangement 34 can be used at least partially also as sensors 10 for the driving system devices 6, and vice versa, if redundancy is not desired due to safety considerations. For example, the longitudinal vehicle speed sensor 12b of the distance control device 8 can simultaneously also serve as a sensor of the sensor arrangement 34.

According to the figure, there is also a setting arrangement 36 present which is used to manually predefine driving parameters. The driver can influence, as driving parameters, for example the steering behaviour (degree of directness of the steering, steering transmission ratio), the pedal characteristics, the engine control etc. in order to be able to select a sporty, comfortable or other vehicle configuration variant. In this context, in order to set the overall vehicle characteristics, the driver can be given a choice between various modes such as “sports”, “comfort”, “standard” etc. The setting arrangement 36 is electrically connected to the coordination device 18 and transmits setting signals to the coordination device 18.

In the coordination device 18, the vehicle characteristics which have been selected by the driver at a particular time and the resulting setting values of the vehicle devices such as steering device 28, brake device 27, engine control device 29 etc. can be determined from the setting signals of the setting arrangement 34. For example it is possible specifically for the “steering transmission ratio” which can be set in a variable fashion in an electronic steering device or for the degree of damping of a spring and damper device (not illustrated here in more detail) which is set at a particular time to be determined from the above. As these setting values influence the driving behaviour of the vehicle, they must be known when the driving state (stability or instability) is assessed. The coordination device 18 is connected to a feedback arrangement 40 via a fourth conductor arrangement 38.

It is to be noted at this point that, instead of the electrical conductor arrangements 19, 30, 35, 38, it is possible, in a modification of the preferred exemplary embodiment, also to provide an optical waveguide arrangement, for example by means of an optical waveguide. Any other desired transmission arrangement between the devices which are connected by the conductor arrangements which are provided is basically also possible.

The driving system devices 6 generate output signals as a function of the driving state variables which are determined by the sensors 10 of the respective driving system device 6. The driving state variables which are determined by the various driving system devices 6 depend on the specific function of the respective driving system device 6, each driving system device 6 being assigned merely one partial safety aspect of the overall driving state of the vehicle for monitoring, controlling or adjusting. For example, the distance control device 8 can determine the distance from the vehicle travelling ahead and the relative speed of the two vehicles. The tyre pressure warning device determines the tyre pressure in all the tyres of the vehicle and the brake/steering aid 7 determines the position of obstacles and the relative speed of the vehicle in relation to the detected obstacles.

If one of the driving system devices 6 determines a driving state variable which does not lie in a correspondingly acceptable range, the respective driving system device 6 generates an output signal. By reference to the output signals present at a time, the coordination device 18 can bring about an intervention of a respective actuator device 26 of the vehicle and/or generate a feedback signal which is passed on to the feedback arrangement 40 in order to bring about visual and/or audible and/or haptic driver feedback. The driver feedback serves to inform the driver of the driving state of the vehicle. Driver feedback can, for example, also take the form of the communication of automatic interventions of the driving system devices 6 which are carried out at a particular time. For example, the driver can be informed about an automatic braking intervention by the displaying of the corresponding symbol in a display panel in the region of the dashboard and/or by a corresponding audible output.

The coordination function of the coordination device 18 in relation to the request to adjust or control the vehicle state by means of an intervention in one of the actuator devices 26 is the subject-matter of the patent application by the applicant submitted on the same day with the title “Verfahren und Vorrichtung zur Koordination mehrerer Fahrsystemeinrichtungen eines Fahrzeugs [Method and device for coordinating a plurality of driving system devices of a vehicle]“(internal file number: P033164/DE/1), to the complete content of which reference is made at this point.

The coordination of the output signals with respect to the feedback of the current driving state to the driver is described in the present application.

The output signals which are present are transmitted to the coordination device 18 by means of the first conductor arrangement 19. The coordination device 18 is used to generate a feedback signal for the feedback arrangement 40 from the output signals brought about by the driving system devices 6. The feedback signal is determined in the coordination device 18 as a function of the output signals, present at the calculation time, of the driving system devices 6.

If only one output signal of one of the driving system devices 6 is present, the feedback signal corresponds to this output signal. If a plurality of output signals of different driving system devices 6 are present, prioritization for the formation of the feedback signal is carried out in the coordination device 18.

In order to prioritize the output signals during the determination of the feedback signal, it is possible to divide the driving system devices 6 into groups, the various groups of driving system devices 6 being assigned different group priorities. The output signals of the driving system devices 6 of a group of driving system devices 6 with a high group priority have precedence of use in the determination of the feedback signal over the output signals which originate from driving system devices 6 of a group of driving system devices 6 with a low group priority.

The number of groups of driving system devices 6 which are formed can in principle be determined as desired. For example, the driving system devices 6 could be divided into three groups: a safety system device group, to which all the safety-related driving system devices 6 are assigned, a comfort system device group to which the driving system devices 6 which relate only to the comfort of the driver are assigned, and a warning system device group which is assigned the driving system devices 6 which do not request to be acted on by actuator devices 26 which influence the movement of the vehicle, but which instead warn the driver against a current, unacceptable driving state. Here, the safety system devices can be assigned the highest group priority, and the warning devices the lowest group priority. In a modification of this, the driving system devices 6 can also be divided into other different groups or a different assignment of priorities is possible.

With the described prioritization by means of group priorities it is possible only to take into account the output signals of the driving system devices 6 which belong to a common group of driving system devices 6. In one preferred configuration of the method, the group priority of the groups of driving system devices whose driving system devices 6 have generated at least one output signal which is unequal to zero is compared, and only the control signals which are assigned to the driving system devices 6 of the group with the comparatively highest group priority are taken into account during the determination of the control result signal.

In combination with, or as an alternative to, the group priorities, the driving system devices 6 can also be assigned driving system priorities. As has already been explained in conjunction with the group priorities, the driving system priorities are also used to give the output signals of the driving system devices 6 different priorities as a function of the driving system priority during the determination of the feedback signal. Here, the driving system devices 6 of a common group of driving system devices can be assigned different driving system priorities. If the driving system devices 6 are not divided into different groups, each individual driving system device 6 can be assigned a driving system priority.

The priorities are basically assigned to the driving system devices 6 in accordance with the weighting. When the feedback signal is generated, it is possible to take into account either only the output signals which originate from the driving system devices 6 with the comparatively highest priority, or a plurality of output signals whose driving system devices 6 have different priorities, are also used to determine the feedback signal. The maximum number of output signals which are taken into account can be limited in order to restrict the information which is simultaneously fed back to the driver so that, in particular in critical driving situations, for example when an unstable driving state is present, the driver is not overtaxed, but is nevertheless sufficiently informed.

In addition, there is, for example, provision for the coordination device 18 to take into account further signals in order to determine the feedback signal. The signals obtained by the coordination device 18 in the present case are in the form of sensor signals of the sensor arrangement 34, in the form of setting signals of the setting arrangement 36 and in the form of a driving state signal of the driving dynamics control unit 23. The information from the setting signals, sensor signals and the driving state signal can serve as additional evaluation criteria in the determination of the feedback signal. It is, for example, conceivable that the priorities of the driving system devices 6 are not invariable but rather are determined as a function of the sensor signals and/or setting signals and/or the driving state signal. These additional signals can, however, also be included directly in the determination of the feedback signal by means of the coordination device 18 and are therefore treated by the coordination device 18 as an output signal of the driving system devices 6.

The actuator devices 26 communicate, for example, their operating state to the driving dynamics control unit 23 by means of the second conductor arrangement 30. The operating state of the actuator devices is used to generate the driving state signal of the driving dynamics control unit 23. The operating state of the actuator devices 26 is consequently also communicated to the coordination device by means of the driving state signal.

The feedback arrangement 40 is provided for generating a visual and/or audible and/or haptic driver feedback message as a function of the received feedback signal. This can thus be a display on a display panel, an audible signal or speech output or else a force acting on the driver—such as vibrations—for providing haptic driver feedback. Any desired combinations of the visual, audible and haptic output forms are also possible.

Here, any possible output signal can be assigned a specific, predeterminable driver feedback, the assignment being, for example, stored in a memory.

If the feedback signal takes into account a plurality of output signals, a new driver feedback message can be generated as a function of the feedback signal, for example from the driver feedback assigned to the output signals which are taken into account.

Another possibility is to predefine a specific driver feedback message for each possible feedback signal and to store it in a memory, all the output signals which occur as well as their possible combinations being already taken into account. It is not necessary to generate new driver feedback messages as a function of the feedback signal here.

In order to provide the haptic driver feedback, the feedback arrangement contains a feedback actuator unit 42 which can bring about feedback variables, such as feedback forces or feedback torques, which can be transmitted to the driver so that specific forces occurring during driving—for example during steering or braking—can be conveyed to the driver as it were by simulation. Such feedback variables are also used in a normal uncritical driving state to convey a safe and accustomed driving sensation to the driver.

The feedback actuator unit 42 can have a steering simulation actuator if the vehicle is equipped with an electric steering operator control. The steering simulation actuator brings about a feedback steering variable on the steering operator control during manual steering, for example a feedback steering torque or a feedback steering force—as a function of the configuration of the steering operator control as a joystick-like steering operator control or as a steering wheel. The feedback steering variable correlates to the wheel steering force which acts on the steerable wheels when they are deflected. The relationship between the wheel steering force and the feedback steering force can be predefined as desired by means of programming in an electric steering device.

If the vehicle has an electric brake operator control, the feedback actuator unit 42 can have a brake simulation actuator which, during braking, applies to the brake operator control a feedback brake variable which correlates to the braking behaviour of the vehicle. For example, any desired relationship can be predefined between the braking force which is set by means of the brake device and the feedback brake variable which is formed by a feedback braking force.

When a critical driving state is present, the feedback variables mentioned above can be influenced by means of the feedback actuator unit 42. A superimposed signal which serves to inform and in particular to warn the driver of a critical driving state can be superimposed on the feedback variables, such as feedback brake variable or feedback steering variable, which are simulated during the normal, uncritical driving state as driver feedback. A critical driving state is present if an unstable driving state is reached or is to be expected. The respective superimposed signal is requested from the coordination device 18 by means of the feedback signal. The feedback actuator unit 42 then superimposes the requested superimposed signal on the respective feedback variable and outputs the haptic driver feedback which has been produced. For example it is possible in this way to generate vibration, slight oscillation or the like at the brake operator control and/or at the steering operator control.

The superimposition can be implemented by means of addition, modulation or some other type of superimposition.

In order to warn the driver about a critical driving state—in particular about an unacceptable yaw behaviour of the vehicle—the feedback actuator unit 42 can also have a rolling angle influencing actuator. If the feedback signal indicates an unacceptable yaw behaviour, the unacceptable yaw behaviour can be communicated to the driver haptically by the setting of a corresponding yaw angle of the vehicle by means of the yaw angle influencing actuator. The yaw angle which is set by means of the yaw angle influencing actuator can increase as the vehicle approaches a critical driving state.

1. Method for providing feedback on the current driving state of a vehicle having a plurality of driving system devices (6) to the driver, the driving system devices (6) bringing about, as a function of the current driving state, output signals from which a feedback signal for a feedback arrangement (40) of the vehicle is generated, which feedback arrangement brings about a driver feedback message in order to provide information on the current driving state,
characterized in that
the output signals of the driving system devices (6) are present simultaneously, and in that the feedback signal is generated from the output signals which are present simultaneously, the output signals which are present simultaneously being prioritized for this purpose.

2. Method according to claim 1, characterized in that the driving system devices (6) are divided into a plurality of groups with different group priorities, the output signals of a group with a relatively high group priority being used with priority during the generation of the feedback signal in comparison with the output signals of the driving system devices (6) of a group with a relatively low group priority, and/or in that the individual driving system devices (6) are assigned a driving system priority in accordance with the weighting of the respective driving system device (6).

3. Method according to claim 2, characterized in that the driving system devices (6) are divided up into groups in terms of their function.

4. Method according to claim 3, characterized in that driving system devices (6) which require an automatic safety intervention are assigned to a group with a high group priority, and driving system devices (6) which are used only to warn the driver are assigned to a group with a low group priority.

5. Method according to claim 2, characterized in that only the output signals of the driving system devices (6) of a single group of driving system devices (6) are taken into account in order to generate the feedback signal.

6. Method according to one of claims 1 to 5, characterized in that each output signal of the driving system devices (6) is assigned a predefinable driver feedback message.

7. Method according to one of claims 1 to 6, characterized in that each feedback signal is assigned a predefinable driver feedback message.

8. Method according to claim 7, characterized in that, when a feedback signal which takes into account a plurality of the present output signals of the driving system devices (6) is present, a new driver feedback message is generated as a function of the combination of the output signals which are taken into account.

9. The method as claimed in claim 7 or 8, characterized in that, for each possible feedback signal, a corresponding driver feedback message is stored in a memory.

10. Method according to one of claims 1 to 9, characterized in that, during the generation of the feedback signal, further signals, in particular sensor signals from vehicle sensors (34) which contain information on the current driving state of the vehicle and/or setting signals which correspond to manual settings by the driver, are taken into account, in addition to the output signals of the driving system devices (6).

11. Method according to claim 10, characterized in that the vehicle sensors (34) contain information on the yaw angle speed and/or the vehicle acceleration and/or the vehicle speed and/or the wheel speeds and/or the steering wheel torque and/or the steering wheel angle.

12. Method according to claim 1, characterized by visual and/or audible and/or haptic driver feedback.

13. Device for providing feedback on the current driving state of a vehicle having a plurality of driving system devices (6) to the driver, according to one of claims 1 to 11, the driving system devices (6) bringing about, as a function of the current driving state, output signals from which a feedback signal for a feedback arrangement (40) of the vehicle is generated in a coordination device (18), the feedback arrangement (40) bringing about a driver feedback message in order to convey information on the current driving state, characterized in that the output signals of the driving system devices (6) are present simultaneously, and in that the feedback signal is generated from these output signals which are present simultaneously, the simultaneously present output signals being prioritized for this purpose.

14. Device according to claim 13, characterized in that the feedback arrangement (40) can be used to bring about a visual and/or audible and/or haptic driver feedback message as a function of the feedback signal.

15. Device according to claim 13 or 14, characterized in that, in order to bring about a haptic driver feedback message, the feedback arrangement (40) has a feedback actuator unit (42) which has the purpose of providing the driver with at least some of the variables, such as forces or torques, which occur during driving, by bringing about feedback variables which act on the driver.

16. Device according to claim 15, characterized in that, when a critical driving state is present, the feedback signal can be used to influence feedback variables brought about in the feedback actuator unit (42), in order to inform or warn the driver.

17. Device according to claim 15 or 16, characterized in that, in order to provide the driver with feedback on the wheel steering force acting on the steerable wheels of the vehicle, counter to the deflection movement of the wheels during steering, the feedback actuator unit (42) has a steering simulation actuator which generates, on the steering operator control, a feedback steering variable which correlates with the wheel steering force.

18. Device according to one of claims 15 to 17, characterized in that, in order to provide the driver with feedback on the braking behaviour of the vehicle, the feedback actuator unit (42) has a brake simulation actuator which brings about, at the brake operator control, a feedback brake variable which correlates with the braking behaviour of the vehicle, in particular with the braking force.

19. Device according to one of claims 15 to 18, characterized in that, in order to provide the driver with feedback particularly on an unacceptable yaw behaviour of the vehicle, the feedback actuator unit (42) has a rolling angle influencing actuator which influences the rolling angle.

20. Device according to claim 19, characterized in that the rolling angle of the vehicle which is brought about by the rolling angle influencing actuator increases as the vehicle approaches the unstable yaw behaviour.

21. Device according to one of claims 13 to 20, characterized in that the coordination device (18) is connected to a driving state adjustment or control unit (22), in particular driving dynamics control unit (23), the driving state adjustment or control unit (22) being able to transmit a driving state signal to the coordination device. (18), which signal is taken into account in the generation of the feedback signal.

22. Device according to claim 21, characterized in that the driving state adjustment or control unit (22) is connected to actuator devices (26) of the vehicle such as the steering device (28) or brake device (27), the actuator devices (26) being able to communicate their operating state to the driving state adjustment or control unit (22), which takes into account the operating state of the actuator devices (26) when the driving state signal is brought about.

23. Device according to claim 13, characterized in that the driving system devices (6) are divided into a plurality of groups with different group priorities, the output signals of a group with higher group priority having precedence of use during the generation of the feedback signal over the output signals of the driving system devices (6) of a group with lower group priority, and/or in that a driving system priority is assigned to the individual driving system devices (6) in accordance with the weighting of the respective driving system device (6).

24. Device according to claim 23, characterized in that the driving system devices (6) are divided into groups in terms of their function.

25. Device according to claim 24, characterized in that driving system devices (6) which request an automatic safety intervention are assigned to a group with high group priority, and driving system devices (6) which are used only to warn the driver are assigned to a group with low group priority.

26. Device according to claim 23 characterized in that only the output signals of the driving system devices (6) of a single group of driving system devices (6) are taken into account in order to generate the feedback signal. the actuator devices (26) being able to communicate their operating state to the driving state adjustment or control unit (22), which takes into account the operating state of the actuator devices (26) when the driving state signal is brought about.
